(19) United States
(12) Patent Application Publication
(10) Pub. No.: US 2025/0080153 A1
(43) Pub. Date: Mar. 6, 2025

(54) SYSTEM AND METHOD FOR ENABLING A STANDALONE OUTDOOR SMALL CELL DESIGN

(71) Applicant: JIO PLATFORMS LIMITED, Ahmedabad (IN)

(72) Inventors: Deepak GUPTA, Navi Mumbai (IN); Amrish BANSAL, Navi Mumbai (IN); Nekiram KHOSYA, Dombivali East (IN); Renuka NAIR, Dombivali East (IN); Brijesh SHAH, Navi Mumbai (IN); Narender KUMAR, Gurgaon (IN)

(73) Assignee: JIO PLATFORMS LIMITED, Ahmedabad (IN)

(21) Appl. No.: 18/724,734

(22) PCT Filed: Dec. 20, 2022
(86) PCT No.: PCT/IB2022/062526

§ 371 Date: Jun. 27, 2024

(30) Foreign Application Priority Data
Dec. 29, 2021 (IN) 202121061401

(51) Int. Cl. H04B 1/40; H04B 1/04; H04J 3/06; H04W 16/32

(52) U.S. Cl. CPC H04B 1/40; H04J 3/0638; H04W 16/32; H04B 2001/0408

(57) ABSTRACT

The present invention provides an efficient and reliable systems and methods for facilitating standalone mode for an outdoor Small Cell (ODSC) for 5G. The system can be an all-in-one self-contained unit that houses an entire next generation Node B (gNB) functionality including but not limited to radio transceiver. an RF front end as well as antenna. The system may further include a network processor and an FPGA integrated on at least 18 but not limited to the like layers of an Integrated baseband and Transceiver board. The Integrated baseband and Transceiver board may further include a Clock synchronization architecture using system synchronizer IC and clock generators. The system can develop an LI layer and generate a bitstream in the FPGA while providing blind mating and a cable less design.

### FIELD OF INVENTION

The embodiments of the present disclosure generally relate to telecommunication deployment. More particularly, the present disclosure relates to systems and methods for an overall hardware design architecture of an Outdoor Small Cell (ODSC) design for standalone mode.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

A modern mobile communications network comprises of a combination of different cell types and different access technologies. As cellular networks evolve from 4G, 5G and then to 6G along with other radio access technologies such as Wi-Fi, the mobile subscriptions are also exponentially increasing. Thus, the deployment of very high-density heterogeneous networks (HetNets) to fulfil the demands of the subscribers has become increasingly important too.

5G base-stations (BS) are called 5G Base-station Distributed Unit (gNB-DU). In 5GREM, macro 5G BS (gNB-DUm) are overlaid by small cell (gNB-DUs). Macro gNB can provide good coverage and capacity. However, in some cases, dense urban environment with high-rise buildings may face mobile coverage problem at certain times and adding more radios will be not feasible. In some scenarios, providing enough capacity to high number of mobile users at commercial hubs like malls, hotels, office blocks or transportation hubs will also be very challenging. Also, difficulties arise in Hotspot locations where traffic demand is significantly high and cannot be served by 4G/5G gNB alone for coverage and capacity boosts.

Therefore, there is a need in the art to provide systems and methods that can overcome the shortcomings of the existing prior art.

### OBJECTS OF THE PRESENT DISCLOSURE

Some of the objects of the present disclosure, which at least one embodiment herein satisfies are as listed herein below.

An object of the present disclosure is to provide a system with cable less design.

An object of the present disclosure is to provide a system that facilitates an easy way to deploy the system on lighting poles.

An object of the present disclosure is to provide a cost-effective solution as compared to the available solutions.

An object of the present disclosure is to provide a system that meets all the RF performance requirement mentioned in 3GPP standard (TS 38.141) after integrating time division duplex (TDD) based 5G NR ODSC with Crest Factor Reduction (CFR) and Digital Pre-Distortion (DPD) modules in Digital Front End lineup.

An object of the present disclosure is to provide a system that facilitates low power consumption and overcome thermal issues by the ingress protected mechanical housing.

An object of the present disclosure is to provide a multi-layer high density interconnect board having baseband section, RF section and DC section for the generation of 28V, 12V and 5V from the single −48V input.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for an outdoor small cell (ODSC) system. The system may include a single enclosure configured to house an integrated baseband and transceiver board, a radio frequency (RF) Frond End board, and a multi-input multi output (MIMO) Antenna. The integrated baseband and transceiver board may be further configured to blind mate with the RF Front end board through unique one or more mating bullets configured to provide robust connection between the integrated baseband and transceiver board and the RF front end board. The blind mating of the integrated baseband and transceiver board and the RF front end board provides a cable less design. The single housing unit may be designed on a multi-layer printed circuit board (PCB) configured to route a set of RF signals and a set of predefined signals running on high speed on adjacent layers and operate in micro class for providing macro-level wide-area solutions for coverage and capacity.

In an embodiment, the integrated baseband and transceiver board may include a Baseband Processor chipset for L2 and L3 layer processing and an FPGA chipset for L1 layer processing. The system may be further configured to generate a bitstream in the FPGA chipset.

In an embodiment, the integrated baseband and transceiver board may be configured to receive an external predefined input voltage and down convert the external predefined input voltage to a plurality of lower voltages based on requirements from a plurality of devices on the integrated baseband and transceiver board.

In an embodiment, the plurality of lower voltages may be generated by a Power management integrated chipset (PMIC), one or more DC-DC converters and one or more linear and low dropout (LDO) regulators devices.

In an embodiment, the plurality of devices in the integrated baseband and transceiver board may include a plurality of complex sub-systems comprising any or a combination of digital high-speed signals, switching power supplies, clock section and radio frequency signal.

In an embodiment, a clock and synchronization circuit may be integrated in the integrated baseband and transceiver board. The clock and synchronization circuit may be configured to synchronize the plurality of devices in the integrated baseband and transceiver board with a standard external clock and implement holdover requirement as per predefined telecom standards.

In an embodiment, the clock and synchronization circuit may include one or more ultra-low noise clock generation phase locked loops (PLLs), a programmable oscillator and a system synchronizer.

In an embodiment, the RF front end board may include one or more RF power amplifiers, one or more Low noise amplifiers (LNA), one or more RF switches and a cavity filter.

In an embodiment, the RF front end board may receive a combination of a set of control signals and power supply from the integrated baseband and transceiver board along with the power supply through a connector connected with the RF front end board.

In an embodiment, the connector may include any or a combination of a plurality of transmit chains for signal transmission, a plurality of receive chains for signal reception and a plurality of observation chains acting as feedback paths for linearization.

In an embodiment, each transmit chain may carry a matching Balun, a pre-driver amplifier, and an RF power amplifier, each receive chain may carry a low noise amplifier band pass surface acoustic wave (SAW) filter and a matching network, and each observation chain may carry a directional coupler, a digital step attenuator (DSA) and a matching network.

In an embodiment, the enclosure further may house the cavity filter operatively coupled between the integrated baseband and transceiver board and the RF Front end board. The housing unit may be designed on at least an 18 layer PCB board.

In an embodiment, the cavity filter further may include at least a four-port cavity filter configured to provide steeper roll-off outside operating band.

In an embodiment, the MIMO antenna may include at least a four port cross-polarized patch antennas.

In an embodiment, the single enclosure may be a passively cooled enclosure with a predefined weight that is less than 11 kg and made of IP65 mechanically ingress protected material configured to be installed in a plurality of tower sites and lamp-posts.

In an aspect, the present disclosure provides for an outdoor small cell (ODSC) device. The device may include a single enclosure configured to house an integrated baseband and transceiver board, a radio frequency (RF) Frond End board, and a multi-input multi output (MIMO) Antenna. The integrated baseband and transceiver board may be further configured to blind mate with the RF Front end board through unique one or more mating bullets configured to provide robust connection between the integrated baseband and transceiver board and the RF front end board. The blind mating of the integrated baseband and transceiver board and the RF front end board provides a cable less design. The single housing unit may be designed on a multi-layer printed circuit board (PCB) configured to route a set of RF signals and a set of predefined signals running on high speed on adjacent layers and operate in micro class for providing macro-level wide-area solutions for coverage and capacity.

In an aspect, the present disclosure provides for method for designing an outdoor small cell (ODSC) system. The method may include the steps of configuring a housing unit to house an integrated baseband and transceiver board, a radio frequency (RF) Frond End board, and a multi-input multi output (MIMO) Antenna; blind mating the integrated baseband and transceiver board with the RF Front end board through one or more mating bullets. The one or more mating bullets provide connection between the integrated baseband and transceiver board and the RF front end board. The method further includes the step of designing the housing unit on a multi-layer printed circuit board (PCB). The multi-layer printed circuit board (PCB) may route a set of RF signals and a set of predefined signals running on high speed on adjacent layers and operate in micro class for providing the solutions for coverage and capacity in heterogenous network along with Macro cells.

In an aspect, the present disclosure provides for a user equipment (UE) communicatively coupled with an outdoor small cell (ODSC) system. The coupling may include the steps of receiving a connection request, sending an acknowledgment of connection request to the ODSC system and transmitting a plurality of signals in response to the connection request.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an exemplary system architecture in which or with which proposed system of the present disclosure can be implemented, in accordance with an embodiment of the present disclosure.

FIG. 1B illustrates an exemplary high-level system architecture in which or with which proposed system of the present disclosure can be implemented, in accordance with an embodiment of the present disclosure.

FIG. 2 illustrates an exemplary high-level architecture of integrated baseband and transceiver board in which or with which proposed system of the present disclosure can be implemented, in accordance with an embodiment of the present disclosure.

FIG. 3 illustrates an exemplary architecture of Clock Section, in accordance with an embodiment of the present disclosure.

FIG. 4 illustrates an exemplary RF Front End architecture in a single chain, in accordance with an embodiment of the present disclosure.

FIG. 5 illustrates an exemplary method flow diagram of the present disclosure, in accordance with an embodiment of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present invention provides an efficient and reliable systems and methods for facilitating standalone mode for an outdoor Small Cell (ODSC) for a communication network. The system can be an all-in-one self-contained unit that houses an entire next generation Node B (gNB) functionality including but not limited to radio transceiver, an RF front end as well as antenna. The system may further include a network processor and an FPGA integrated on a multi-layer integrated baseband and transceiver board. The Integrated baseband and Transceiver board may further include a Clock synchronization architecture using system synchronizer IC and clock generators. The system can develop an L1 layer and generate a bitstream in the FPGA while providing blind mating and a cable less design.

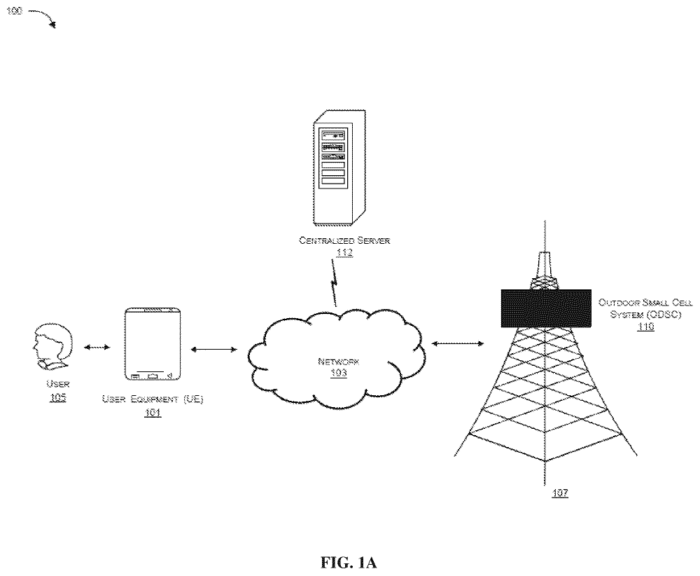

FIG. 1A illustrates an exemplary system architecture in which or with which proposed system of the present disclosure can be implemented, in accordance with an embodiment of the present disclosure. Referring to FIG. 1A that illustrates an exemplary network architecture (100) for an outdoor small cell system (ODSC) (110) in which or with which the proposed system (110) can be implemented, in accordance with an embodiment of the present disclosure. As illustrated, the exemplary network architecture (100) may be equipped with the proposed system (110) that may be associated with a base station (107). The base station (107) may be communicatively coupled to a user equipment (101) via a communication network (103).

In an embodiment, the UE (101) may be communicatively coupled to the ODSC (110). The coupling can be through a wireless network 103. In an exemplary embodiment, the communication network 103 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The UE 101 can be any handheld device, mobile device, palmtop, laptop, smart phone, pager and the like. As a result of the coupling, the UE 101 may be configured to receive a connection request from the ODSC 110, send an acknowledgment of connection request to the ODSC 110 and further transmit a plurality of signals in response to the connection request.

Referring to FIG. 1B that illustrates an exemplary system architecture (100) for facilitating 5G communication in an outdoor small cell (ODSC) (also referred to as system architecture (100)) in which or with which the system (110) of the present disclosure can be implemented, in accordance with an embodiment of the present disclosure. As illustrated, the exemplary system (110) may be equipped with an integrated baseband and transceiver (IBTB) board (102), radio frequency Frond End (RFRE) board (104), a cavity filter (106) and a multi-input multi output (MIMO) Antenna (108).

In an exemplary embodiment, the IBTB (102) may include integrated RF transceivers that greatly reduces the RF challenges. The transceivers provide a digital interface for the analog RF signal chain and allow easy integration to an ASIC or FPGA for the baseband processing. The baseband processor allows user data to be processed in the digital domain between an end application and the transceiver device. An RFRE board is a circuitry between a receiver's antenna input up to and including a mixer stage. It consists of all the components in the receiver that process the signal at the original incoming radio frequency (RF), before it is converted to a lower intermediate frequency (IF). In microwave and satellite receivers it is often called the low-noise block downconverter (LNB) and is often located at the antenna, so that the signal from the antenna can be transferred to the rest of the receiver at the more easily handled intermediate frequency.

In an exemplary embodiment, Cavity filters are a type of resonant filter used for either passing desired RF signals within a specified frequency range or rejecting RF signals within a range of frequencies while the MIMO antenna is an antenna technology for wireless communications in which multiple antennas are used at both the source (transmitter) and the destination (receiver)

In an exemplary embodiment, the system (110) may be enclosed in a housing unit. The housing unit is a self-contained unit. The system (110) may be but not limited to a medium power gNB that can operate in but not limited to micro class such as 6.25 W or 38 dB per antenna port but not limited to the like.

In an exemplary embodiment, the system (110) can complement macro-level wide-area solutions for coverage and capacity, and is particularly useful in hot zone/hot spot areas with high traffic and quality of service (QoS) demands.

In an exemplary embodiment, the system (110) can bring together an application layer, a medium access control (MAC) layer and a baseband layer based on a network processor or a Baseband Processor chipset, an RF transceiver based on FPGA and the RF front end module (FEM) that can include one or more RF power amplifiers, one or more Low noise amplifiers (LNA), one or more RF switches and one or more cavity filters in the self-contained unit.

In an exemplary embodiment, the self-contained unit can be a passively cooled enclosure and weighing less than but not limited to 11 kg.

In an exemplary embodiment, the system (110) can facilitate 5G new radio (NR) communication in the network.

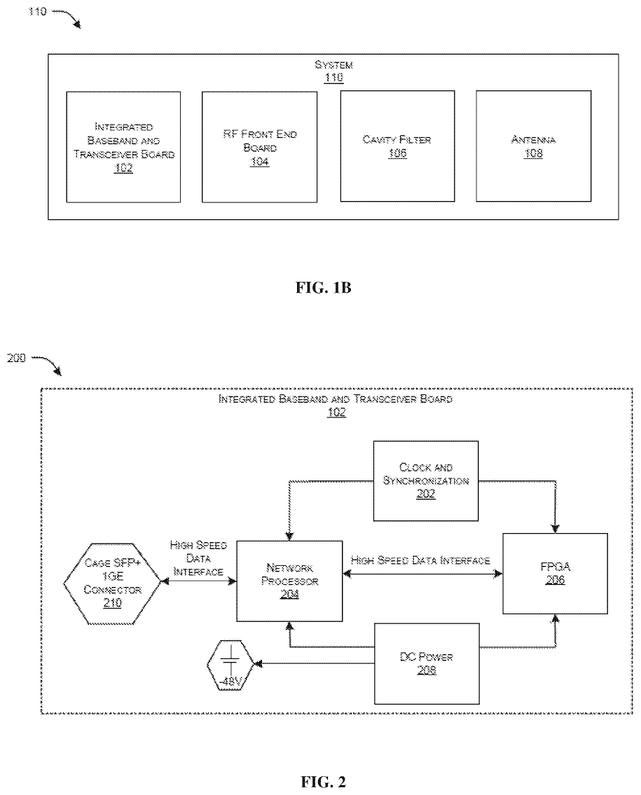

FIG. 2 illustrates an exemplary high-level architecture of integrated baseband and transceiver board in which or with which proposed system of the present disclosure can be implemented, in accordance with an embodiment of the present disclosure. As illustrated, in an aspect the integrated baseband and transceiver board (102) may include a network processor (204) (also referred to as the Baseband Processor (204) herein) chipset for an L2 and an L3 layer processing and FPGA (206) chipset for L1 layer processing. The integrated baseband and transceiver board (102) can receive an external but not limited to a −48V input DC voltage (208) and then can down convert the external input voltage to a plurality of voltages lower than the external input voltage based on requirements from a plurality of devices on the integrated baseband and transceiver board (102). In an exemplary embodiment, a power management integrated chipset (PMIC), DC-DC converters and linear and low dropout (LDO) regulators devices can be used to generate the plurality of voltages lower than the external input voltage.

In an aspect, the integrated baseband and transceiver board (102). May further include a plurality of sub-systems such as digital high speed signals, switching power supplies, clock section and radio frequency signal and the like (210) and may be designed on an but not limited to an 18-Layers high density interconnect (HDI) PCB.

In an exemplary embodiment, the 18 or more layers PCB design may include unique design techniques to route RF signals and PCIe Gen 3.0 signals running on high speed 8 GT/s on adjacent layers and meet predefined design specifications.

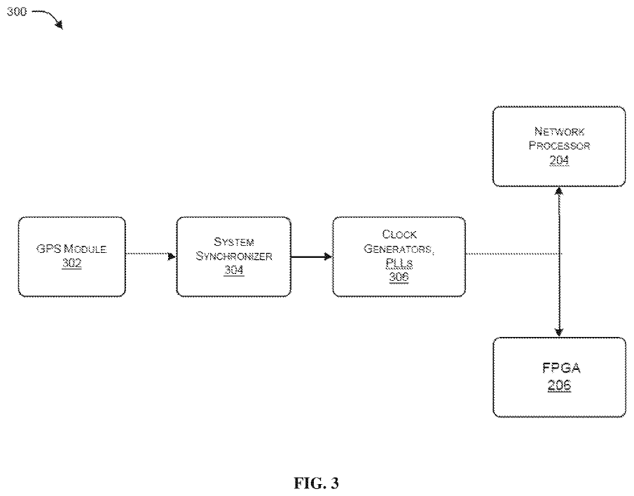

In an embodiment, the system can be synchronized within the integrated baseband and transceiver board (IBTB) (102) and to a plurality of external devices using a clock and synchronization circuit (202) on the integrated baseband and transceiver board (102). With reference to FIG. 3, in an aspect the clock and synchronization circuit (202) may include a clock generation phase locked loops (PLLs) (302), Programmable oscillator and a system synchronizer (304). This system can also take care of holdover requirement as per telecom standards. In an exemplary embodiment, the clock generation PLLs can be ultra-low noise clock generation PLLs, but not limited to it. Rising data rates in high-speed serial communications buses require such PLL system clock solutions. PLL-based frequency synthesizers using integer N and fractional N topologies provide stable, low noise signals for high frequency clock, serial data communications, and radar applications for frequencies up to tens of gigahertz. The Programmable oscillator and a system synchronizer (304) performs phase locking and locks to a common frequency with constant phase differences. The nodes are digitally-controlled-oscillators (DCOs) coupled via vector multipliers implemented by composing (analog) CMOS Gilbert multipliers. It is scalable to large numbers of nodes as well as finer feature size technologies.

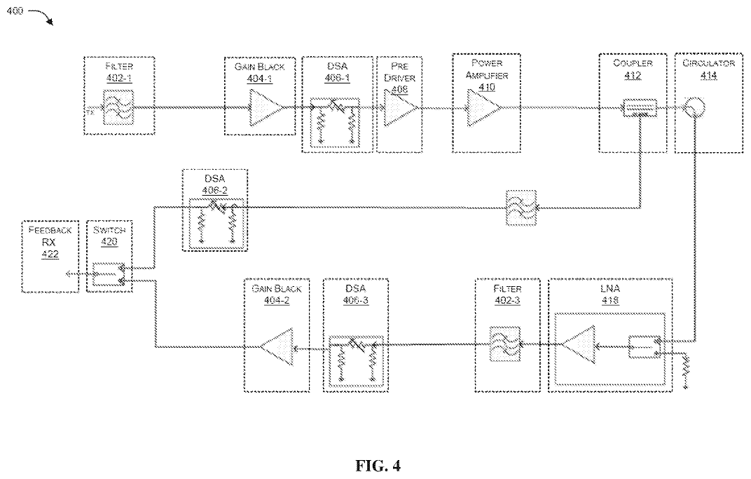

FIG. 4 illustrates an exemplary RF Front End architecture in a single chain, in accordance with an embodiment of the present disclosure. As illustrated, in an aspect, the RF front end (RFFE) board (104) may receive a set of control signals from IBTB (102) along with a power supply through a connector of the RFFE Board (104). The RFFE board may accommodate at least four transmit chains for signal transmission, at least four receive chains for signal reception and at least four observation chains which act as DPD feedback paths from a plurality of power amplifiers (PA) (410) to FPGA for linearization.

In an embodiment, each transmit chain may carry matching Balun, pre-driver amplifier (408) and Final RF power amplifier as a final stage PA (410).

In an embodiment, each receive chain may carry a low noise amplifier band pass SAW filter (418) and matching network.

In an embodiment, each observation chain may carry a directional coupler (412), digital step attenuator (DSA) (406) and a matching network.

In an embodiment, an RF TDD switch (420) may combine each transmit-receive pair.

In an embodiment, a Circulator (414) and a cavity filter (402) can be used between each RF switch to antenna port.

In an exemplary embodiment, the RF Front End Board (RFFE) (104) may blind mate with the Integrated Baseband and Transceiver Board (IBTB) (102) thus removing the complexity of cable routing to avoid RF signal oscillations. The mating bullets provides robust connection between the IBTB (102) and the RFFE (104). The blind mating also provides advantages such as reduced production, installation, and maintenance costs, shorter assembly time, fewer errors during assembly, shorter downtime, and no special tools are required, less stress and frustration for the user, minimal impact on the size or weight of the design and fewer mismatched connections.

The system may a target output of but not limited to 25 W.

In an exemplary embodiment, the cavity filter (106 or 402) may include at least a four-port cavity filter for an but not limited to a 4T4R configuration that can provide a steeper roll-off outside operating band.

In an exemplary embodiment, the MIMO Antenna (108) board may include at least a four-port cross-polarized patch antennas used for but not limited to the 4T4R configuration.

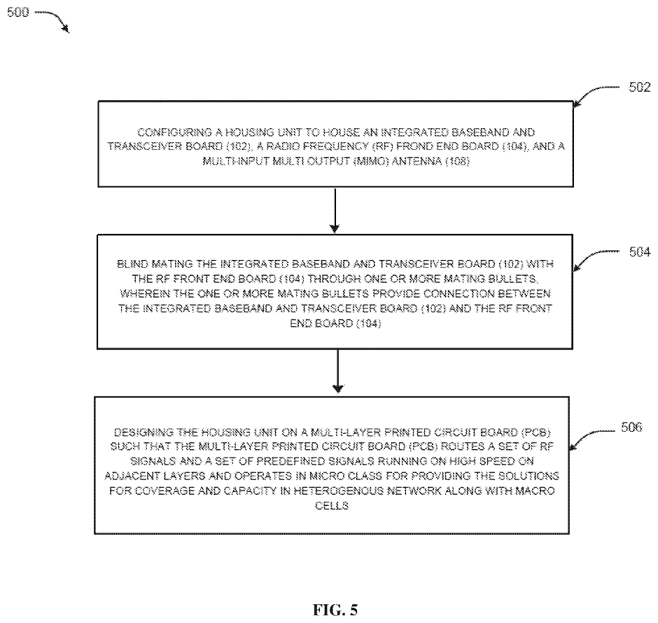

FIG. 5 illustrates an exemplary method flow diagram (500) of the present disclosure, in accordance with an embodiment of the present disclosure.

In an aspect, the method (500) for designing an outdoor small cell (ODSC) system may include at 502, the step of configuring a housing unit to house an integrated baseband and transceiver board, a radio frequency (RF) Frond End board, and a multi-input multi output (MIMO) Antenna.

The method may further include at 504, the step of blind mating the integrated baseband and transceiver board with the RF Front end board through one or more mating bullets. The one or more mating bullets provide connection between the integrated baseband and transceiver board and the RF front end board.

The method further includes at 506, the step of designing the housing unit on a multi-layer printed circuit board (PCB) such that the multi-layer printed circuit board (PCB) may route a set of RF signals and a set of predefined signals running on high speed on adjacent layers and operate in micro class for providing the solutions for coverage and capacity in heterogenous network along with Macro cells.

Thus, the present disclosure provides for a unique and efficient 5G outdoor small cell design that can be compact with integrated antenna solution without any use of cable. The system can be easily installed in a plurality of tower sites and lamp-posts. The system deployment can be easy and fast while delivering high performance with low power consumption. The system can offer at least two 1G Fiber Optic (SFP) as a backhaul connection to networks.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

The present disclosure has implemented 3GPP standard pertaining to TS 38.141. A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### Advantages of the Present Disclosure

The present disclosure provides for a cable less design.

The present disclosure provides for a system that facilitates an easy way to deploy on Lighting or electric poles.

The present disclosure provides for a cost-effective solution as compared to the available solutions.

The present disclosure provides for a system that meets all the RF performance requirement mentioned in 3GPP standard (TS 38.141) after integrating TDD based 5G NR ODSC with Crest Factor Reduction (CFR) and Digital Pre-Distortion (DPD) modules in Digital Front End line-up.

The present disclosure provides for a system that facilitates low power consumption and thermal issues by the ingress protected mechanical housing.

The present disclosure provides for a multi-layer high density interconnect board having baseband section, RF section and DC section for the generation of 28V, 12V and 5V from the single −48V input.

We claim:

1. An outdoor small cell (ODSC) system (110), said system (110) comprising:
a housing unit, said housing unit is configured to house an integrated baseband and transceiver board (102), a radio frequency (RF) Frond End board (104), and a multi-input multi output (MIMO) Antenna (108),
wherein the integrated baseband and transceiver board (102) is configured to blind mate with the RF Front end board (104) through one or more mating bullets configured to provide connection between the integrated baseband and transceiver board (102) and the RF front end board (104), and
wherein the housing unit is designed on a multi-layer printed circuit board (PCB) configured to route a set of RF signals and a set of predefined signals running on high speed on adjacent layers and operate in micro class for providing the solutions for coverage and capacity in heterogenous network along with Macro cells.

2. The ODSC system as claimed in claim 1, wherein the integrated baseband and transceiver board (102) comprises a Baseband Processor chipset (204) for L2 and L3 layer processing and an FPGA chipset (206) for L1 layer processing, wherein the system (110) is configured to generate a bitstream in the FPGA chipset.

3. The ODSC system as claimed in claim 1, wherein the integrated baseband and transceiver board (102) is configured to:
receive an external predefined input voltage;
down convert the external predefined input voltage to a plurality of lower voltage values based on requirements from a plurality of devices on the integrated baseband and transceiver board (102).

4. The ODSC system as claimed in claim 3, wherein the plurality of lower voltage values are generated by a Power management integrated chipset (PMIC), one or more DC-DC converters and one or more linear and low dropout (LDO) regulators devices.

5. The ODSC system as claimed in claim 3, wherein the plurality of devices in the integrated baseband and transceiver board comprises a plurality of complex sub-systems comprising any or a combination of digital high-speed signals, switching power supplies, clock section and radio frequency signal.

6. The ODSC system as claimed in claim 3, wherein a clock and synchronization circuit (202) is integrated in the integrated baseband and transceiver board (102), wherein the clock and synchronization circuit (202) is configured to:
synchronize the plurality of devices in the integrated baseband and transceiver board (102) with a standard external clock; and enable holdover.

7. The ODSC system as claimed in claim 5, wherein the clock and synchronization circuit (202) comprises one or more ultra-low noise clock generation phase locked loops (PLLs (302)), a programmable oscillator and a system synchronizer (304).

8. The ODSC system as claimed in claim 1, wherein the RF front end board (104) comprises one or more RF power amplifiers, one or more Low noise amplifiers (LNA), one or more RF switches and a cavity filter (106, 402).

9. The ODSC system as claimed in claim 6, wherein the RF front end board (104) receives a combination of a set of control signals and power supply from the integrated baseband and transceiver board (102) along with the power supply through a connector connected with the RF frontend board (104).

10. The ODSC system as claimed in claim 7, wherein the connector comprises any or a combination of plurality of transmit chains for signal transmission, plurality of receive chains for signal reception and plurality of observation chains acting as feedback paths for linearization.

11. The ODSC system as claimed in claim 8, wherein each said transmit chain carries a matching Balun, a pre-driver amplifier, and an RF power amplifier, wherein each said receive chain carries a low noise amplifier band pass surface acoustic wave (SAW) filter and a matching network, and wherein each said observation chain carries a directional coupler, a digital step attenuator (DSA) and a matching network.

12. The ODSC system as claimed in claim 1, wherein the enclosure further houses a cavity filter (106) operatively coupled between the integrated baseband and transceiver board (102) and the RF Front end board (104), and wherein the housing unit is designed on at least an 18 layer PCB.

13. The ODSC system as claimed in claim 14, wherein the cavity filter further comprises a multi-port cavity filter configured to provide steeper roll-off outside operating band.

14. The ODSC system as claimed in claim 14, wherein the MIMO antenna comprises at least a four-port cross-polarized patch antennas.

15. The ODSC system as claimed in claim 1, wherein the single enclosure is a passively cooled enclosure with a predefined weight that is less than 11 kg, wherein the single enclosure is made of IP65 mechanically ingress protected material and wherein the single enclosure is configured to be installed in a plurality of tower sites and lamp-posts.

16. An outdoor small cell (ODSC) device, said device comprising:
a single enclosure, said enclosure configured to house an integrated baseband and transceiver board (102), a radio frequency (RF) Frond End board (104), and a multi-input multi output (MIMO) Antenna (108),
wherein the integrated baseband and transceiver board (102) is configured to blind mate with the RF Front end board (104) through unique one or more mating bullets configured to provide robust connection between the integrated baseband and transceiver board (102) and the RF front end board (104), and
wherein the single housing unit is designed on a multi-Layer printed circuit board (PCB) configured to route a set of RF signals and a set of predefined signals running on high speed on adjacent layers and operate in micro class for providing macro-level wide-area solutions for coverage and capacity.

17. The ODSC device as claimed in claim 16, wherein the integrated baseband and transceiver board (102) comprises a Baseband Processor chipset for L2 and L3 layer processing and an FPGA chipset for L1 layer processing, wherein the system (110) is configured to generate a bitstream in the FPGA chipset.

18. The ODSC device as claimed in claim 16, wherein the integrated baseband and transceiver board (102) is configured to:
receive an external predefined input voltage;
down convert the external predefined input voltage to a plurality of lower voltages based on requirements from a plurality of devices on the integrated baseband and transceiver board (102).

19. The ODSC device as claimed in claim 18, wherein the plurality of lower voltages is generated by a Power management integrated chipset (PMIC), one or more DC-DC converters and one or more linear and low dropout (LDO) regulators devices.

20. The ODSC device as claimed in claim 18, wherein the plurality of devices in the integrated baseband and transceiver board comprises a plurality of complex sub-devices comprising any or a combination of digital high-speed signals, switching power supplies, clock section and radio frequency signal.

21. The ODSC device as claimed in claim 18, wherein a clock and synchronization circuit is integrated in the integrated baseband and transceiver board (102), wherein the clock and synchronization circuit is configured to:
synchronize the plurality of devices in the integrated baseband and transceiver board (102) with a standard external clock;
implement holdover requirement as per predefined telecom standards.

22. The ODSC device as claimed in claim 21, wherein the clock and synchronization circuit comprise one or more ultra-low noise clock generation phase locked loops (PLLs), a programmable oscillator and a device synchronizer.

23. The ODSC device as claimed in claim 16, wherein the RF front end module comprises one or more RF power amplifiers, one or more Low noise amplifiers (LNA), one or more RF switches and a cavity filter.

24. The ODSC device as claimed in claim 23, wherein the RF front end board receives a combination of a set of control signals and power supply from the integrated baseband and transceiver board (102) along with the power supply through a connector coupled to the RF front end board (104).

25. The ODSC device as claimed in claim 24, wherein the connector comprises any or a combination of a plurality of transmit chains for signal transmission, a plurality of receive chains for signal reception and a plurality of observation chains which act as feedback paths from for linearization.

26. The ODSC device as claimed in claim 25, wherein each said transmit chain carries a matching Balun, a pre-driver amplifier, and an RF power amplifier, wherein each said receive chain carries a low noise amplifier band pass surface acoustic wave (SAW) filter and a matching network, and wherein each said observation chain carries a directional coupler, a digital step attenuator (DSA) and a matching network.

27. The ODSC device as claimed in claim 16, wherein the enclosure further houses a cavity filter operatively coupled between the integrated baseband and transceiver board (102) and the RF Front end board, and wherein the housing unit is designed on at least an 18 layer PCB.

28. The ODSC device as claimed in claim 29, wherein the cavity filter further comprises at least a four-port cavity filter configured to provide steeper roll-off outside operating band.

29. The ODSC device as claimed in claim 16, wherein the MIMO antenna comprises at least a four-port cross-polarized patch antennas

30. The ODSC device as claimed in claim 16, wherein the single enclosure is a passively cooled enclosure with a predefined weight that is less than 11 kg, wherein the single enclosure is made of IP65 mechanically ingress protected material and wherein the single enclosure is configured to be installed in a plurality of tower sites and lamp-posts.

31. A method for designing an outdoor small cell (ODSC) system (110), said method comprising:
configuring a housing unit to house an integrated baseband and transceiver board (102), a radio frequency (RF) Frond End board (104), and a multi-input multi output (MIMO) Antenna (108);
blind mating the integrated baseband and transceiver board (102) with the RF Front end board (104) through one or more mating bullets, wherein the one or more mating bullets provide connection between the integrated baseband and transceiver board (102) and the RF front end board (104); and
designing the housing unit on a multi-layer printed circuit board (PCB) such that the multi-layer printed circuit board (PCB) routes a set of RF signals and a set of predefined signals running on high speed on adjacent layers and operates in micro class for providing the solutions for coverage and capacity in heterogenous network along with Macro cells.

32. A user equipment (UE) communicatively coupled with an outdoor small cell (ODSC) system, said coupling comprises steps of:
receiving a connection request;
sending an acknowledgment of connection request to the ODSC system; and
transmitting a plurality of signals in response to the connection request, wherein said outdoor small cell (ODSC) system (110) is as claimed in claim 1.
